(19) United States
(12) Patent Application Publication
(10) Pub. No.: US 2022/0212044 A1
(43) Pub. Date: Jul. 7, 2022

(54) EXTERIOR FIRE SUPPRESSING SYSTEM

(71) Applicant: Douglas Allen Yates, Duluth, MN (US)

(72) Inventor: Douglas Allen Yates, Duluth, MN (US)

(21) Appl. No.: 17/142,418

(22) Filed: Jan. 6, 2021

(51) Int. Cl. A62C 3/02; B05B 3/04; B05B 15/622; B05B 15/658

(52) U.S. Cl. CPC A62C 3/0214; B05B 3/0472; E04H 12/32; B05B 15/658; B05B 15/622

(57) ABSTRACT

An exterior fire suppressing system includes a flagpole that has a bottom end and an upper end. The flagpole has a height above a ground surface that is greater than 10.0 feet when the bottom end of the flagpole is anchored in the ground surface. A halyard is mounted on the flagpole and engages a flag to raise and lower the flag on the pole. The flagpole has a conduit therein for transporting a fluid. The conduit has an inlet positioned adjacent to the bottom end and an outlet adjacent to the upper end. A water sprinkler is mounted on the flagpole and is fluidly coupled to the outlet. The water sprinkler is rotatable and disperses water in an arcuate pattern extending outwardly from the flagpole wherein the flagpole defines an axis of the arcuate pattern of dispersed water. A hose connector is fluidly mounted to the inlet.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to fire suppressing device and more particularly pertains to a new fire suppressing device for wetting dwellings in a remote area utilizing a flagpole mounted water sprinkler and an adjacent body of water.

### (2) Description of Related Art Including Information Disclosed Under 37 CFR 1.97 and 1.98

The prior art relates to fire suppressing devices and in particular sprinkler systems used for wetting areas to prevent their ignition by an approaching fire.

### BRIEF SUMMARY OF THE INVENTION

An embodiment of the disclosure meets the needs presented above by generally comprising a flagpole that has a bottom end and an upper end. The flagpole has a height above a ground surface that is greater than 10.0 feet when the bottom end of the flagpole is anchored in the ground surface. A halyard is mounted on the flagpole and engages a flag to raise and lower the flag on the pole. The flagpole has a conduit therein for transporting a fluid. The conduit has an inlet positioned adjacent to the bottom end and an outlet adjacent to the upper end. A water sprinkler is mounted on the flagpole and is fluidly coupled to the outlet. The water sprinkler is rotatable and disperses water in an arcuate pattern extending outwardly from the flagpole wherein the flagpole defines an axis of the arcuate pattern of dispersed water. A hose connector is fluidly mounted to the inlet.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front isometric view of a flagpole of an exterior fire suppressing system according to an embodiment of the disclosure.

FIG. 2 is a broken front isometric view of an embodiment of the disclosure.

FIG. 3 is a side view of an embodiment of the disclosure.

FIG. 4 is a cross-sectional view of an embodiment of the disclosure taken along line 4-4 of FIG. 2.

FIG. 5 is side in-use a side in-use view of an embodiment of the disclosure.

FIG. 6 is a top schematic view of an embodiment of the disclosure.

### DETAILED DESCRIPTION OF THE INVENTION

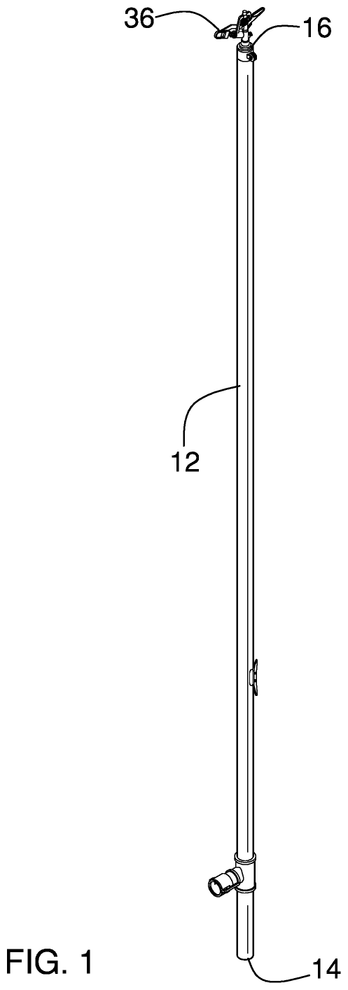

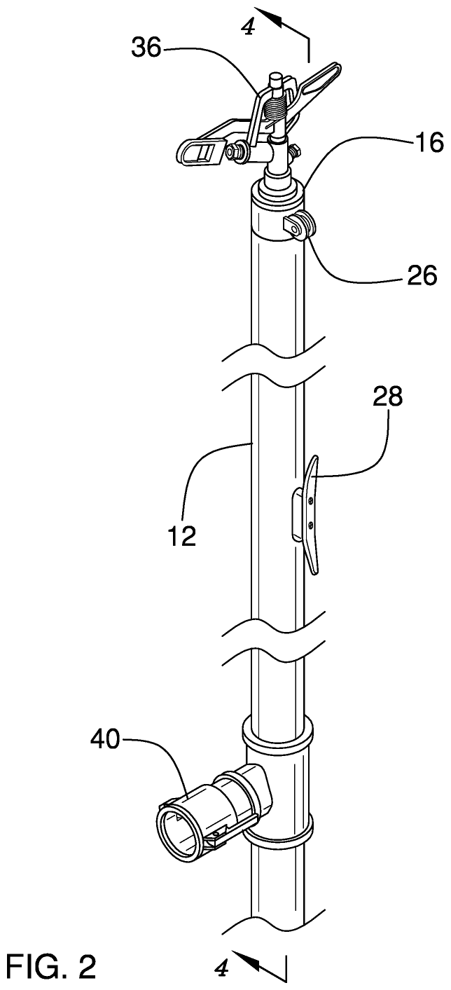

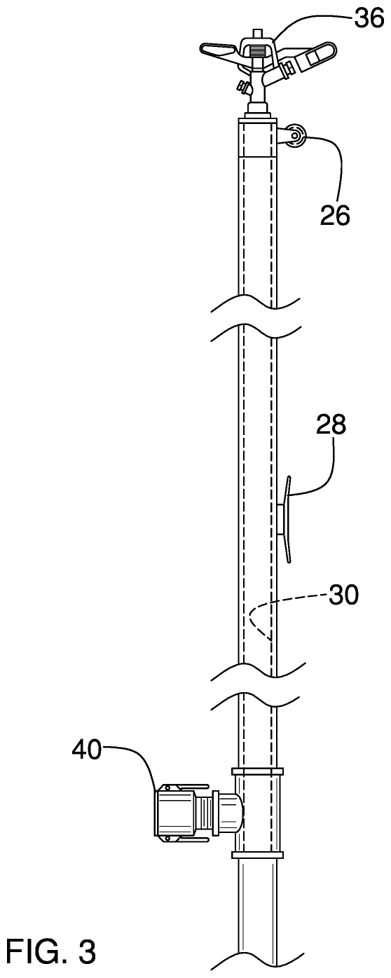

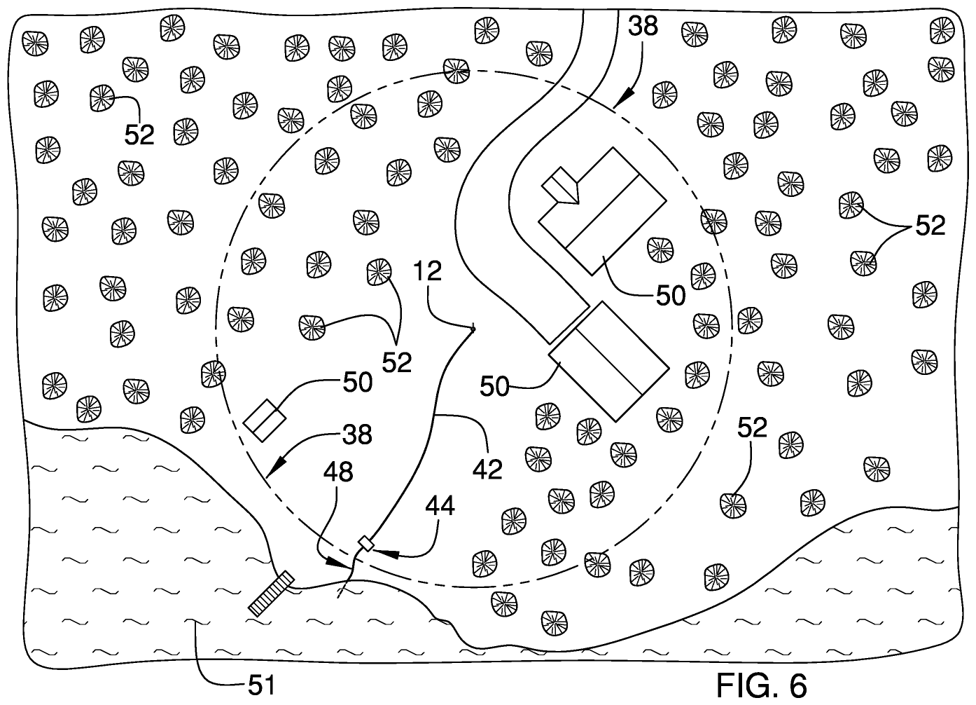

With reference now to the drawings, and in particular to FIGS. 1 through 6 thereof, a new fire suppressing device embodying the principles and concepts of an embodiment of the disclosure and generally designated by the reference numeral 10 will be described.

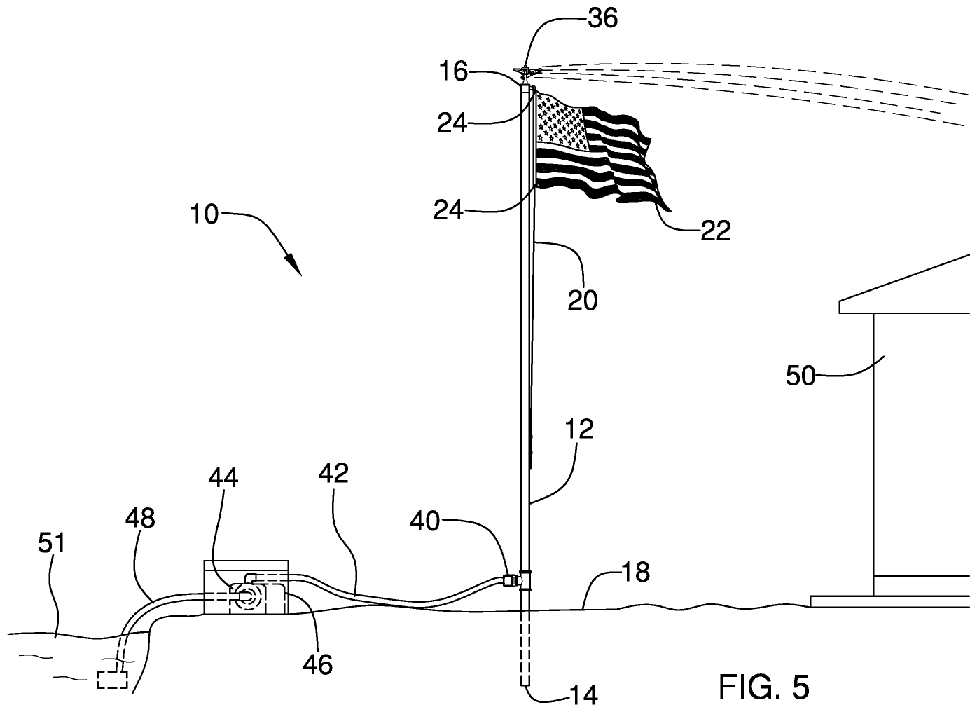

As best illustrated in FIGS. 1 through 6, the exterior fire suppressing system 10 generally includes a support which has the ornamental appearance and function of a flagpole 12. The flagpole 12 has a bottom end 14 and an upper end 16. The flagpole 12 has a height above a ground surface 18 that is greater than 10.0 feet when the bottom end 14 of the flagpole is anchored in the ground surface 18 as shown in FIG. 5. The flagpole 12 may be anchored in any conventional manner used for anchoring flagpoles such as, for example, embedding the bottom end 14 and a portion of the flagpole 12 adjacent thereto within concrete. The height of the flagpole 12 may vary depending on the needs of the user and will typically not be greater than 30 feet above the ground surface 18. The flagpole 12 is comprised of conventional materials utilized for flagpoles 12 such as steel, aluminum and the like though plastics may also be utilized. The flagpole 12 will typically be constructed of a single, unitary structure, though the flagpole 12 may be provided in sections that are securable together.

A halyard 20 is mounted on the flagpole 12 and is configured to engage a flag 22 to raise and lower the flag 22 on the flagpole 12. Attached to halyard 20 are clips 24 for securing the flag 22 to the halyard 20. Pulleys 26 and tie-downs 28 are positioned on the flagpole 12 for allowing free movement and releasably securing of the halyard 20 relative to the flagpole 12.

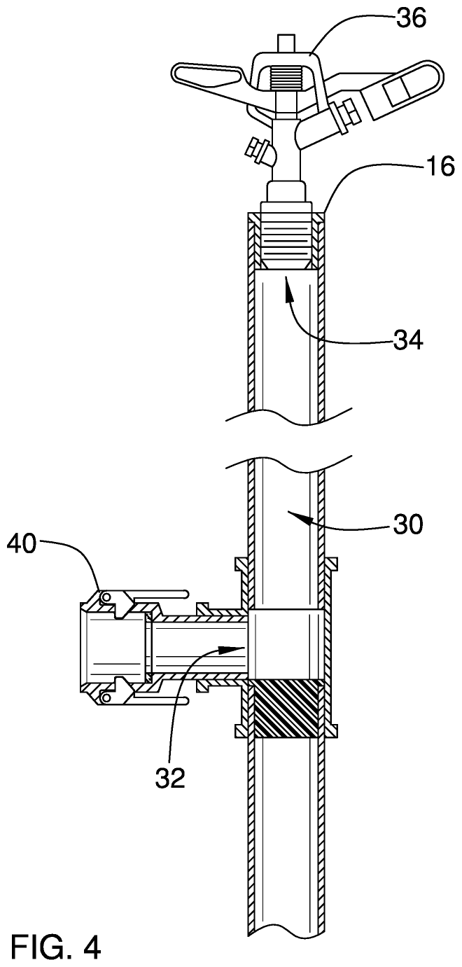

The flagpole 12 has a conduit 30 therein configured for transporting a fluid, which in particular will likely comprise water. The conduit 30 may be formed by a perimeter wall of the flagpole 12 itself as shown in FIG. 4 or may be tube mounted within and being independent from the flagpole 12. The conduit 30 has an inlet 32 extending through the flagpole 12 and positioned adjacent to the bottom end 14 and an outlet 34 extending through the flagpole 12 and being positioned adjacent to the upper end 16. Though not required, the conduit 30 may have a diameter that decreases from the inlet 32 to the outlet 34 to increase the pressure of water flowing through the conduit 30 as it flows from the inlet 32 to the outlet 34.

A water sprinkler 36 is mounted on the flagpole 12 and is fluidly coupled to the outlet 34. The water sprinkler 36 is generally conventional and is rotatable, or more particularly its spout is rotatable, relative to the flagpole 12 such that the water sprinkler 36 disperses water in an arcuate pattern 38 extending outwardly from the flagpole 12 wherein the flagpole 12 defines an axis of the arcuate pattern 38 of dispersed water. The water sprinkler 36 may comprise what is conventionally known as an impact sprinkler or a turbine sprinkler capable of dispensing up to greater than 20.0 gallons per minute of water and a throw, or dispersant range, of greater than 60.0 feet away from the water sprinkler 36.

A hose connector 40 is fluidly mounted to the inlet 32. The hose connector 40 may comprise any conventional connector that forms a suitable fluid connection with a water hose 42 to be fluidly coupled to the hose connector 40. A water pump 44 is fluidly coupled to the water hose 42. The water pump 44 may include water pumps that are powered by fuel or electricity but will typically comprise a water pump 44 with an internal combustion engine fluidly coupled to a fuel tank 46. An advantage of using a gasoline powered water pump 44 is that the water pump 44 will automatically shut down when its fuel tank 46 has been exhausted of fuel and the water pump 44 will not be dependent upon a constant source of electricity.

A supply hose 48 is fluidly coupled to the water pump 44 for drawing water from a water source 51 by the water pump 44 when the water pump 44 is turned on. The supply hose 48 is positionable in a body of water which will function as the water source 51 for the system 10. The water pump 44 draws water from the body of water, and pressurizes the water to supply the water hose 42 and water sprinkler 36 with pressurized water. The body of water will most typically comprise a remote body of water which may be used due to the lack of other water sources. Thus, the body of water may include lakes, ponds, rivers and the like. A swimming pool may also be useful as a source of water.

In use, the system 10 is positioned, and more particularly the flagpole 12 is positioned, such that a dwelling 50 is located within a radius of the arcuate pattern 38 of the water sprinkler 36 when water is ejected by the water sprinkler 36. When the water pump 44 is turned on, it will draw water from an adjacent body of water, such as a lake, that is relatively near to the dwelling 50. The dwelling 50 may comprise a cabin, house, or outbuilding that is located in a remote area which may not have a source of pressurized water. The water pump 44 will wet the roof of the dwelling 50 as well as the ground and trees 52 within the arcuate pattern 38. The water pump 44 is turned on when a fire is approaching the dwelling 50 to prevent the fire from igniting the trees 52 and the dwelling(s) 50. The water pump 44 is provided with enough fuel to sufficiently saturate the dwelling 50 and surrounding area before the fuel is exhausted.

As should be understood from the above and from the Figures, the system 10 is used in remote areas such as cabins or homes found within a remote, wilderness area. While these areas offer a rustic setting, they cannot be easily accessed by firefighters and are often lost in wildfires due to this lack of access. However, these locations are often selected due to their proximity to a body of water that may be used for firefighting purposes. The system 10 will therefore prevent wildfire losses and is easily retrofitted in locations it will benefit. Furthermore, the system 10, by utilizing a flagpole 12, will be aesthetically inconspicuous while serving the additional purpose of flying a flag 22. This will allow the system 10 to also be easily integrated into residential areas where risk of wildfires are high, but which have a swimming pool that can be accessed as the water source 51 for dousing an adjacent house with pool water.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A fire suppressing system configured to inhibit the encroachment of fire within a designated area, the system comprising:
a flagpole having a bottom end and an upper end, the flagpole having a height above a ground surface being greater than 10.0 feet when the bottom end of the flagpole is anchored in the ground surface;
a halyard being mounted on the flagpole and being configured to engage a flag to raise and lower the flag on the pole;
the flagpole having a conduit therein configured for transporting a fluid, the conduit having an inlet positioned adjacent to the bottom end and an outlet adjacent to the upper end;
a water sprinkler being mounted on the flagpole and being fluidly coupled to the outlet, the water sprinkler being rotatable and dispersing water in an arcuate pattern extending outwardly from the flagpole wherein the flagpole defines an axis of the arcuate pattern of dispersed water; and
a hose connector being fluidly mounted to the inlet.

2. The fire suppressing system configured to inhibit the encroachment of fire within a designated area according to claim 1, further including:
a water hose being fluidly coupled to the hose connector; and
a water pump being fluidly coupled to the water hose, the water pump including an internal combustion engine and a fuel tank.

3. The fire suppressing system configured to inhibit the encroachment of fire within a designated area according to claim 2, further including a supply hose being fluidly coupled to the water pump, the supply hose being positionable in a body of water, the water pump drawing water from the body of water and pressuring the water to supply the water hose and water sprinkler with pressurized water.

4. A fire suppressing system configured to inhibit the encroachment of fire within a designated area, the system comprising:
a flagpole having a bottom end and an upper end, the flagpole having a height above a ground surface being greater than 10.0 feet when the bottom end of the flagpole is anchored in the ground surface;
a halyard being mounted on the flagpole and being configured to engage a flag to raise and lower the flag on the pole;
the flagpole having a conduit therein configured for transporting a fluid, the conduit having an inlet positioned adjacent to the bottom end and an outlet adjacent to the upper end;
a water sprinkler being mounted on the flagpole and being fluidly coupled to the outlet, the water sprinkler being rotatable and dispersing water in an arcuate pattern extending outwardly from the flagpole wherein the flagpole defines an axis of the arcuate pattern of dispersed water; and
a dwelling being positioned within a radius of the arcuate pattern wherein water ejected by the water sprinkler wets a roof of the dwelling.

5. The fire suppressing system configured to inhibit the encroachment of fire within a designated area according to claim 4, further including:
a hose connector being fluidly mounted to the inlet;
a water hose being fluidly coupled to the hose connector;
a water pump being fluidly coupled to the water hose, the water pump including an internal combustion engine and a fuel tank; and
a supply hose being fluidly coupled to the water pump, the supply hose being positionable in a body of water, the water pump drawing water from the body of water and pressuring the water to supply the water hose and water sprinkler with pressurized water, the body of water being selected from a group comprising a lake, a pond, a river, or a pool.
